(19) United States
(12) Patent Application Publication
(10) Pub. No.: US 2024/0146775 A1
(43) Pub. Date: May 2, 2024

(54) TEMPLATED DOCUMENT STREAM INTEGRATION OF CHECKLIST DATA FOR CYBERTHREAT REMEDIATION

(71) Applicant: SteelCloud LLC, Ashburn, VA (US)

(72) Inventors: Brian Howard Hajost, Ashburn, VA (US); Matthew Richard Heimlich, Lovettsville, VA (US); Jamie Lynne McCoard, Charles Town, WV (US); Andrew Craig Rowe, Sterling, VA (US)

(73) Assignee: SteelCloud LLC, Ashburn, VA (US)

(21) Appl. No.: 17/974,843

(22) Filed: Oct. 27, 2022

(51) Int. Cl. H04L 9/40

(52) U.S. Cl. CPC H04L 63/205; H04L 63/1433

(57) ABSTRACT

Templated document stream integration of checklist data includes loading different checklist templates for a generic endpoint in a computing infrastructure, each containing partially filed data and each corresponding to a different security policy hardening the generic endpoint from a cyberthreat. Specific endpoints are then selected in the computing infrastructure and, for each corresponding specific endpoint, a set of checklists generated, each checklist in the set deriving from a different checklist template and including the partially filled data of one of the different checklist templates. Further, remediation data stored in a data store of an enterprise application is merged into each one of the generated checklists in the set. Finally, the enterprise application is updated with respect to the corresponding one of the selected specific endpoints with the different checklists merging the partially filled data and the remediation data.

### BACKGROUND OF THE INVENTION

### Field of the Invention

The present invention relates to the technical field of maintaining policy compliant computers in a computing infrastructure of different endpoints.

### Description of the Related Art

In computing, hardening is the process of securing a system by reducing its surface vulnerability. This process can include reducing available vectors of attack by removing unnecessary software, usernames or logins, and disabling or removing services, which can lead to a more secure system. There are various methods of hardening systems, which can include applying a patch to the kernel, closing open network ports, and setting up intrusion-detection systems, firewalls, and intrusion prevision systems. In addition, there can be hardening scripts that can, for instance, deactivate unneeded features in configuration files or perform various other protective measures.

Currently, the process of hardening across and between enterprises relies upon the dictates of one or more policies in a document. It is the role of the system administrator, typically, to monitor the endpoints of a computing enterprise in order to ensure continued compliance with any and all policies. To do so, administrators often rely upon automated system scanning to obtain the current status of the controls of the endpoints of the system. The typical remediation scan not only collects data and reports on values found to be non-conforming with the applied policy, but also applies remediating values for out of compliance elements found during the scan. Central to the effective management of compliance, then, is the coordination of all policies applicable to the endpoints of an enterprise with the known state of affairs produced by remediation scanning.

For many enterprise deployments, the process of managing compliance with the very many policies applicable to the endpoints of the deployment requires the tedious and unwieldy maintenance of “checklists”, often kept in the form of markup language formatted documents. Generally, this is a manual “human” process facilitated from a simplistic data management application. Such a manual process would be sufficient were the typical environment to involve only a handful of endpoints and a single policy. But, oftentimes there exists a large number of policies pertinent to a single endpoint and multiple endpoints in a single enterprise deployment, thus requiring the development and management of a composite number of checklists numbering the product of endpoints by policies. Expecting a flawless integration of so many checklists by an individual is not a reasonable expectation.

### BRIEF SUMMARY OF THE INVENTION

Embodiments of the present invention address technical deficiencies of the art in respect to integration of manually generated checklists into an enterprise application managing compliance and remediation of different endpoints in a computer information system exposed to cybersecurity threats. To that end, embodiments of the present invention provide for a novel and non-obvious method for templated document stream integration of checklist data for cyberthreat remediation of a set of target endpoints in a computing infrastructure. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for templated document stream integration of checklist data includes loading different checklist templates for a generic endpoint in a computing infrastructure. Each template contains partially filed data and each corresponds to a different security policy hardening the generic endpoint from a cyberthreat. The method also includes selecting multiple, different, specific endpoints in the computing infrastructure. Then, for each corresponding one of the specific endpoints, a set of checklists may be generated, in that each of the checklists in the set derives from one of the different checklist templates and includes the partially filled data of the one of the different checklist templates. Further, remediation/scan data that had been stored in a data store of an enterprise application as representative of a state of each of the computing controls of a corresponding one of the specific endpoints subsequent to a scan operation or a remediation operation, and which pertains to remediation of cyberthreats for the corresponding one of the selected specific endpoints, is then merged into each one of the generated checklists in the set. Finally, the enterprise application is updated with respect to the corresponding one of the selected specific endpoints with the different checklists merging the partially filled data and the remediation data.

In one aspect of the embodiment, during the updating, a structured artifact incorporating the partially filled data can be stored along with the remediation data in fixed storage for each one of the generated checklists in the set. In another aspect of the embodiment, comment text is appended to ones of the partially filled data during the merging. To that end, the comment text can include a network address and machine name of the corresponding one of the selected specific endpoints. In yet another aspect of the embodiment, the remediation/scan data includes one or more registry entries produced during a compliance scan of the corresponding one of the selected specific endpoints including remediation values.

In another embodiment of the invention, a data processing system is adapted for templated document stream integration of checklist data for cyberthreat remediation of a set of target endpoints in a computing infrastructure. The system includes a host computing platform with one or more computers, each with memory and one or processing units including one or more processing cores. The system also includes a templated document stream integration module. The module includes computer program instructions enabled while executing in the memory of at least one of the processing units of the host computing platform to load different checklist templates for a generic endpoint in a computing infrastructure, each containing partially filed data and each corresponding to a different security policy hardening the generic endpoint from a cyberthreat.

The program instructions additionally select a multiplicity of specific endpoints in the computing infrastructure. Finally, the program instructions, for each corresponding one of the specific endpoints, generates a set of checklists for the corresponding one of the selected specific endpoints, each of the checklists in the set deriving from one of the different checklist templates and including the partially filled data of the one of the different checklist templates, merges into each one of the generated checklists in the set, remediation/scan data stored in a data store of an enterprise application pertaining to a state of the controls of the corresponding one of the selected specific endpoints subsequent to a scan or remediation operation, and updates the enterprise application with respect to the corresponding one of the selected specific endpoints with the different checklists merging the partially filled data and the remediation data.

In this way, the technical deficiencies of the management of compliance across many different endpoints in the enterprise through the use of completed checklists can be facilitated through the integration of compliance data known for specific endpoints and partially completed checklists generated for the specific endpoints from corresponding checklist templates adapted from a generically defined endpoint. The purpose is to assure a fully populated data set in the enterprise application from information in a collection of source documents each keyed to a specific device (by IP address, for example), that had been generated from a templated form of the source documents, while also assuring the completeness and usability of the source documents separately from the enterprise application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of templated document stream integration of checklist data;

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for the templated document stream integration of checklist data. In accordance with an embodiment of the invention, different checklist templates defined for a generic endpoint load into the integration platform, each including partially filed data corresponding to a different security policy, or set of policies, intended to harden the generic endpoint from a specific cyberthreat. Thereafter, upon selecting multiple different specific endpoints in a computing infrastructure, the integration platform generates a set of checklists for each specific endpoint based upon a corresponding one of the loaded templates and which include the partially filled data of the corresponding one of the loaded templates.

Subsequently, the integration platform first merges remediation data, pertaining to the specific cyberthreat and representative of the state of each of the computing controls of the specific endpoint subsequent to a scan operation or a remediation operation, from a risk management framework (RMF) application into each one of the generated checklists and then updates the RMF application with respect to the specific endpoint with the different checklists merging the partially filled data and the remediation data. In this way, the tedious and error prone process of manually generating checklists for each different endpoint in a network is replaced with the automated generation of the checklists through an integration of templated checklists previously defined, refined with the data from the remediation data of the RMF application, which RMF application is then updated with the information from the generated checklists.

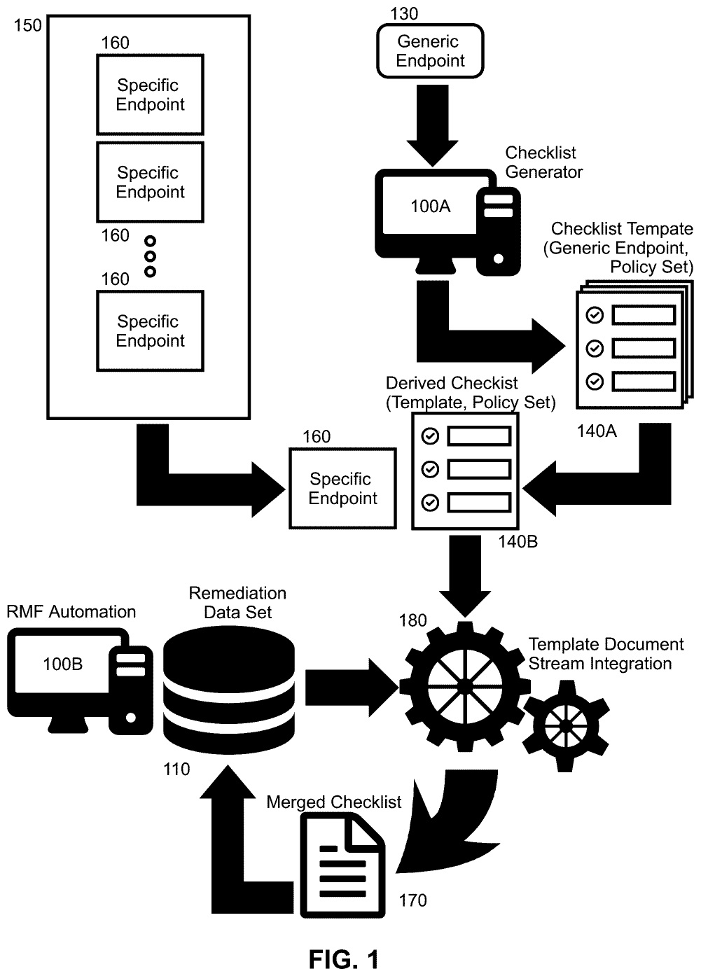

In illustration of one aspect of the embodiment, FIG. 1 pictorially shows a process of templated document stream integration of checklist data. As shown in FIG. 1, a checklist generator 100A defines different checklist templates 140A for a generic endpoint for a computer communications network. The different checklist templates 140A include partially completed fields referring to policy compliance requirements and corresponding implementation facts. Templated document stream integration logic 180 then selects a specific endpoint 160 from a set 150 of the specific endpoints 160 for the computer communications network. The templated document stream integration logic 180 then derives a checklist 140B directed to one or more policies in a policy set for a specified cyberthreat by retrieving one or more of the templates 140A pertaining to the specified policy set and adapting the templates 140A to specifically reference the selected one of the endpoints 160 including an annotation of the network address and name of the selected one of the endpoints 160.

The templated document stream integration logic 180 then queries a remediation data set 110 of the RMF application 100B with respect to the policy set for the specified cyberthreat in order to retrieve from remediation data set 110, remediation data stored in connection with the specified cyberthreat and reflecting a state of each of the computing controls of the selected one of the endpoints subsequent to a scan operation or a remediation operation. The templated document stream integration logic 180 merges into a merged checklist 170, the retrieved remediation data with the derived checklist 140B by mapping elements of the remediation data to individual fields of the derived checklist 140B. Finally, the templated document stream integration logic 180 uploads the merged checklist 170 into the remediation data set 110. Of note, the templated document stream integration logic 180 repeats this process for each of the specific endpoints 160 in the set 150 and for each of the templates 140 for the different policy sets for respective ones of the cyber threats so as to achieve a highly automated, lightning fast uploading of completed and accurate checklists into the RMF application 100B.

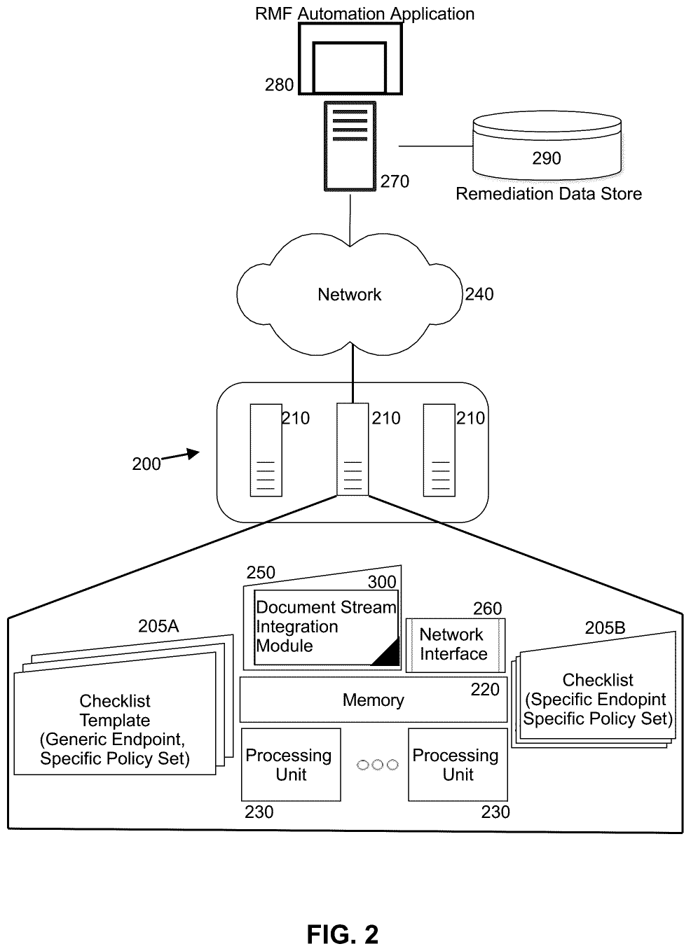

Aspects of the process described in connection with FIG. 1 can be implemented within a data processing system. In further illustration, FIG. 2 schematically shows a data processing system adapted to perform templated document stream integration of checklist data. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

At least one of the computers 210 of the host computing platform 200 has a communicatively coupling over the data communications network 240 to a server 270 hosting the operation of an RMF automation application 280 managing remediation data sets for different endpoints of a network in remediation data store 290. In this regard, the RMF automation application 280 stores risk management and remediation data corresponding to different measures addressing different cybersecurity threats and provides scoring for different implementations of those measures with respect to different endpoints in a monitored and managed network, identifying specific endpoints scoring below an acceptable score threshold for a specific cyber threat. For instance, the remediation data can include one or more registry entries produced during a compliance scan of particular ones of the specific endpoints including remediation values.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for templated document stream integration of checklist data. Specifically, the program instructions during execution load different checklist templates 205A into the memory 220 from fixed storage (not shown) for a generic endpoint in a computing infrastructure, each of the templates 205A containing partially filed data and each corresponding to a different security policy or policies hardening the generic endpoint from a corresponding cyberthreat. Then, the program instructions select multiple different specific endpoints in the computing infrastructure for processing.

For each corresponding specific endpoint, the program instructions first generate a set of checklists 205B for the corresponding one of the selected specific endpoints. Each checklist 205B derives from one or more of the different checklist templates 205A and includes the partially filled data thereof, including manually completed fields of the different checklist templates 205A. The program instructions then merge into each one of the generated checklists 205B, remediation data stored in the remediation data store 290 and that pertain to remediation of cyberthreats for the corresponding specific endpoint. Optionally, the program instructions append comment text to the partially filled data during the merging process, such as comment text provided by the program instructions in respect to a network address and machine name of the specific endpoint, the source of the partially filled data, a time of updating, versioning information, or an identity of the author of the partially filled data, to name a few possibilities.

Finally, the program instructions update the RMF automation application 280 with respect to the corresponding specific endpoint with the checklist 205B including the merged partially filled data and remediation data. In particular, during the updating, the program instructions store in fixed storage, for each generated checklist 205B, a structured artifact incorporating the partially filled data along with the remediation data. In this way, the program instructions enable a fully automated, error-free mass production and uploading of checklist data into the RMF automation application 280 without requiring a tedious manual completion of human acquired data in supplement to the remediation data owing to the derivation of the set of the partially completed checklists 205B for the specific endpoints from the checklist templates 205A of the generic endpoint for particular cyber threats.

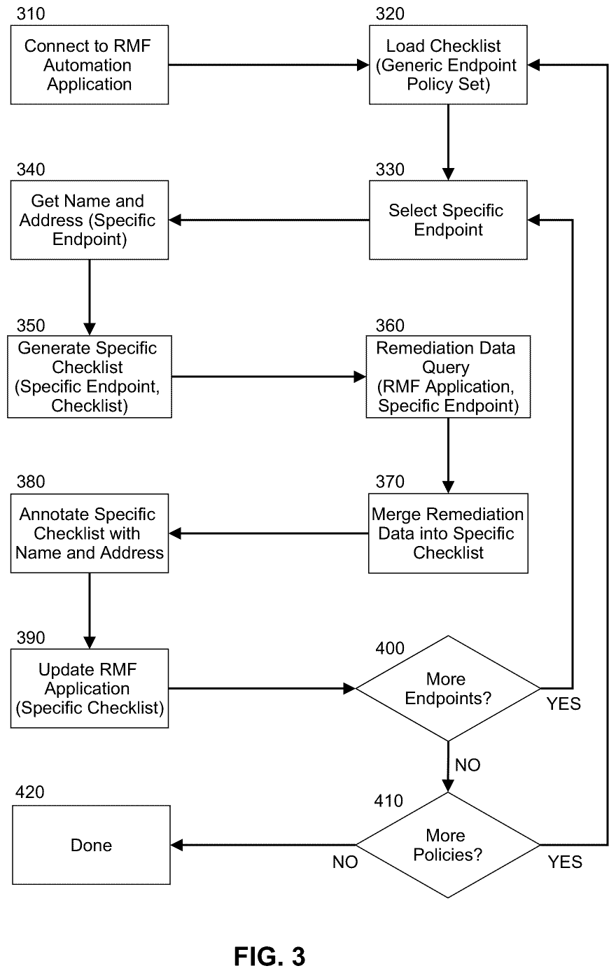

In further illustration of an exemplary operation of the module, FIG. 3 is a flow chart illustrating one of the aspects of the process of FIG. 1. Beginning in block 305, a connection is established with the RMF automation application. Then, in block 320, a set of checklist templates for a generic endpoint corresponding individually to different policy sets addressing respective cyber threats is loaded into memory and in block 330, a specific endpoint in a computer network is selected, such as a specific computer, computing device or network device. Thereafter, in block 340 a name and address for the specific endpoint are determined and in block 350, a specific checklist is generated for the specific endpoint for each of the cyber threats from corresponding ones of the templates.

In block 360, a remediation data store for the RMF automation application is queried in order to retrieve remediation data for the policy set of the specific checklist and the retrieved remediation data is mapped to different fields of the different checklist according to cyber threat and remediation policy element directed to the cyber threat. Once mapped, in block 370 the remediation data is merged accordingly into the different checklist in order to produce a merged checklist. In block 380, the merged checklist is annotated with the name and address of the specific endpoint. Finally, in block 390 the merged checklist is uploaded to the RMF application and the process repeats through decision block 400 for the remaining endpoints in the set until no endpoints remain. Then, to the extent that additional policy sets remain to be processed for additional cyber threats, the process returns to block 320 with the retrieval of a corresponding checklist template continuing through blocks 330 to 390 in the generation of the merged checklist for each of the specific endpoints. In block 410, when no further policy sets remain to be processed, the process ends in block 420.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for templated document stream integration of checklist data for cyberthreat remediation of a set of target endpoints in a computing infrastructure, the method comprising:
loading different checklist templates for a generic endpoint in a computing infrastructure, each containing partially filed data and each corresponding to a different security policy hardening the generic endpoint from a cyberthreat;
selecting a multiplicity of specific endpoints in the computing infrastructure; and,
for each corresponding one of the specific endpoints:
(A) generating a set of checklists for the corresponding one of the selected specific endpoints, each of the checklists in the set deriving from one of the different checklist templates and including the partially filled data of the one of the different checklist templates;
(B) merging into each one of the generated checklists in the set, remediation/scan data stored in a data store of an enterprise application pertaining to remediation of cyberthreats for the corresponding one of the selected specific endpoints and reflecting a state of each of a multiplicity of computing controls of the corresponding one of the selected specific endpoints subsequent to a scan operation or a remediation operation; and,
(C) updating the enterprise application with respect to the corresponding one of the selected specific endpoints with the different checklists merging the partially filled data and the remediation data.

2. The method of claim 1, further comprising during the updating, storing in fixed storage for each one of the generated checklists in the set, a structured artifact incorporating the partially filled data along with the remediation data.

3. The method of claim 1, wherein comment text is appended to ones of the partially filled data during the merging.

4. The method of claim 3, wherein the comment text includes a network address and machine name of the corresponding one of the selected specific endpoints.

5. The method of claim 1, wherein the remediation/scan data comprises one or more registry entries produced during a compliance scan of the corresponding one of the selected specific endpoints including remediation values.

6. A data processing system adapted for templated document stream integration of checklist data for cyberthreat remediation of a set of target endpoints in a computing infrastructure, the system comprising:
a host computing platform comprising one or more computers, each with memory and one or processing units including one or more processing cores; and,
a templated document stream integration module comprising computer program instructions enabled while executing in the memory of at least one of the processing units of the host computing platform to perform:
loading different checklist templates for a generic endpoint in a computing infrastructure, each containing partially filed data and each corresponding to a different security policy hardening the generic endpoint from a cyberthreat;
selecting a multiplicity of specific endpoints in the computing infrastructure; and,
for each corresponding one of the specific endpoints:
(A) generating a set of checklists for the corresponding one of the selected specific endpoints, each of the checklists in the set deriving from one of the different checklist templates and including the partially filled data of the one of the different checklist templates;
(B) merging into each one of the generated checklists in the set, remediation/scan data stored in a data store of an enterprise application pertaining to remediation of cyberthreats for the corresponding one of the selected specific endpoints and reflecting a state of each of a multiplicity of computing controls of the corresponding one of the selected specific endpoints subsequent to a scan operation or a remediation operation; and,
(C) updating the enterprise application with respect to the corresponding one of the selected specific endpoints with the different checklists merging the partially filled data and the remediation data.

7. The system of claim 6, further comprising during the updating, storing in fixed storage for each one of the generated checklists in the set, a structured artifact incorporating the partially filled data along with the remediation data.

8. The system of claim 6, wherein comment text is appended to ones of the partially filled data during the merging.

9. The system of claim 8, wherein the comment text includes a network address and machine name of the corresponding one of the selected specific endpoints.

10. The system of claim 6, wherein the remediation data comprises one or more registry entries produced during a compliance scan of the corresponding one of the selected specific endpoints including remediation/scan values.

11. A computing device comprising a non-transitory computer readable storage medium having program instructions stored therein, the instructions being executable by at least one processing core of a processing unit to cause the processing unit to perform templated document stream integration of checklist data for cyberthreat remediation of a set of target endpoints in a computing infrastructure, the templated document stream integration including:
loading different checklist templates for a generic endpoint in a computing infrastructure, each containing partially filed data and each corresponding to a different security policy hardening the generic endpoint from a cyberthreat;
selecting a multiplicity of specific endpoints in the computing infrastructure; and,
for each corresponding one of the specific endpoints:
(A) generating a set of checklists for the corresponding one of the selected specific endpoints, each of the checklists in the set deriving from one of the different checklist templates and including the partially filled data of the one of the different checklist templates;
(B) merging into each one of the generated checklists in the set, remediation/scan data stored in a data store of an enterprise application pertaining to remediation of cyberthreats for the corresponding one of the selected specific endpoints and reflecting a state of each of a multiplicity of computing controls of the corresponding one of the selected specific endpoints subsequent to a scan operation or a remediation operation; and,
(C) updating the enterprise application with respect to the corresponding one of the selected specific endpoints with the different checklists merging the partially filled data and the remediation data.

12. The device of claim 11, wherein the templated document stream integration further comprises, during the updating, storing in fixed storage for each one of the generated checklists in the set, a structured artifact incorporating the partially filled data along with the remediation data.

13. The device of claim 11, wherein comment text is appended to ones of the partially filled data during the merging.

14. The device of claim 13, wherein the comment text includes a network address and machine name of the corresponding one of the selected specific endpoints.

15. The device of claim 11, wherein the remediation/scan data comprises one or more registry entries produced during a compliance scan of the corresponding one of the selected specific endpoints including remediation values.
